(19) United States
(12) Patent Application Publication
(10) Pub. No.: US 2026/0221321 A1
(43) Pub. Date: Jul. 30, 2026

(54) ELECTRONIC FIBRES AND TEXTILES

(71) Applicant: Imperial College Innovations Limited, London (GB)

(72) Inventors: Felice TORRISI, London (GB); Sihui LIU, London (GB); Francesca WITTMANN, London (GB)

(21) Appl. No.: 19/122,394

(22) PCT Filed: Oct. 19, 2023
(86) PCT No.: PCT/GB2023/052713

§ 371 Date: Apr. 18, 2025

(30) Foreign Application Priority Data
Oct. 19, 2022 (GB) 2215428.0

(51) Int. Cl. H01B 13/32; B05D 1/18; B05D 3/02

(52) U.S. Cl. CPC H01B 13/328; B05D 1/18; B05D 3/0254; B05D 2256/00

(57) ABSTRACT

Described herein are processes for preparation of flexible fibres coated in 2-dimensional materials. These fibres are suitable for use in electronic devices and may be woven to form electronic textiles.

### TECHNICAL FIELD

The present disclosure is related to processes for preparing flexible fibres coated in 2-dimensional materials for use in electronic devices. These fibres may be woven to form e-textiles.

### BACKGROUND OF THE INVENTION

The demand for e-textiles for sensing, photodetection, displays, energy storage is rapidly emerging. Compared with traditional gadgets which are heavy, rigid, and hard-to-wear, textile-based wearable electronics work in a flexible format with clothes' properties such as lightweight, breathable, skin-compatible, washable, stretchable and comfortable. E-textiles can be created from clothes with functionalisation like printing or dyeing, or interweave of numerous functionalised fibres working as transistors, processors, and/or actuators. With a high surface area and capacity to be intertwined and twisted, electronic fibres have shown their unique advantages in device design. Diverse devices such as transistors, photodiodes, photodetectors, solar cells, batteries, supercapacitors, triboelectric nanogenerators and sensors have been developed on these electronic fibres to fulfil various tasks in different regions.

Substantial research has been devoted to the development and manufacturing of electronic fibres, paving the way to a scaled-up production of electronic textiles. The functionalisation of fibre can be processed while fibre spinning or after. This can be implemented by applying a thin (about 10-30 nm) coating around the core fibre with assistance from specific devices and result in a core-shell or multi-faceted structure enabling additional functionalities. This has been accomplished through methods like multi-compartment spinning and co-axial jetting spinning. Multi-compartment spinning is a kind of fibre spinning process that results in multi-faceted fibre composites, controlled the shape by specific spinneret used in electrospinning process, centrifugal electrospinning or fibre printing.

To meet the requirements of various designs, further complex microfluidic tube structures were designed to fabricate multiplex structures through the microfluidic method. These in-line spinning processes yield functionalised fibres with fine controlled structure but strongly rely on the designed spinneret, which limits the design of electronic fibre devices.

Besides the direct spinning of core-shell fibres, subsequent coating of wet-spun functional fibres is another route to produce electronic fibre devices. For example, cotton fibres and yarns with good wettability can be functionalised easily through repeated dipping in a carbon nanotube suspension and then work as a source in a fibre shaped generator that can be woven on textile for wearable applications. Graphene-based fibres can be spun from highly-concentrated graphene oxide (GO) dispersions followed by chemical reduction to yield reduced GO (rGO) fibres. Conductive materials can be decorated on the fibre surface through physical vapour deposition (PVD) or chemical vapour deposition (CVD), for example two-dimensional (2D) materials can be formed on fibres to produce electronic fibre devices, such as a CVD coated MoS₂ layer over rGO fibre to build a flexible fibre shaped photodetector.

However, it is important to stress that CVD of 2D materials requires high temperature (>800° C.) and the handling of toxic/harmful gasses, which make the process not suitable for the wearable textile industry.

Moreover, the integration of electronic textiles into textile circuits requires a wide range of materials acting as different electronic elements to enable diverse applications and ensure mechanical strength for wearable applications. Conductors, semiconductors, insulators and other functional materials like optoelectronic and thermoelectric materials are key components in the design of electronic circuits. However, not all of the materials can be easily deposited on a wired-shape substrate. Some fibre types can be modified via reactions on their surface which makes the coating easier. However, an additional range of functional materials with electrical conductivity, thermal transport and optical properties are needed for high-performance wearable electronic textiles.

Currently, there are limited literature reports over environmental-friendly, sustainable and scalable fibre coating process of graphene and 2D materials such as single layer MoS₂, h-BN and MXenes. 2D materials with large surface area and chemical stability, unique electronic and optical properties and biocompatibility, have shown an enormous potential to be used as wearable electronics. A suitable method to assemble these materials should be able to produce high performance electronic fibres, enable these applications to be wearable.

### SUMMARY OF THE INVENTION

Described herein is a novel process to produce core-shell/multishell fibres with electrical and optical functionalities, suitable for use as electronic textiles. The process forms a functionalised coating around a core fibre composed of, but not limited to, a polymer, a polymer composite, 2D materials and metals, by depositing uniform nanostructured thin-films (e.g. less than about 300 nm) of 2D materials or few-layer (e.g. less than 5 layers) materials including, but not limited to graphene, hexagonal-boron nitride (h-BN), graphene oxide (GO), reduced graphene oxide (rGO), transition metal dichalcogenides (TMDs, e.g. MoS₂, MoSe₂, MoTe₂, WSe₂, WS₂, InS₂, HfS₂), hafnium oxides, transition metal oxides, MXenes (e.g. Ti₃C₂, Ti₂C, Mo₂C, NB₂C) and BiOCl. The process has demonstrated to be scalable and suitable for mass production.

The described process may be used to fabricate various flexible fibre-based electronic components including fibre-shaped photodetectors and fibre-shaped capacitors, which can be woven on the fabric for wearable applications.

In a first aspect, the present invention provides a process for preparing a fibre coated with a 2D material comprising:
providing a fibre;
immersing the fibre in a first ink composition comprising a 2D material and a solvent; and
removing the fibre from the first ink composition and drying the fibre to form a fibre coated with a 2D material.

The 2D material may be graphene, hexagonal-boron nitride (h-BN), graphene oxide (GO), reduced graphene oxide (rGO), transition metal dichalcogenides (TMDs, e.g. MoS₂, MoSe₂, MoTe₂, WSe₂, WS₂, InS₂, HfS₂), hafnium oxides, transition metal oxides, MXenes (e.g. Ti₃C₂, Ti₂C, MO₂C, NB₂C) or BiOCl.

The fibre may comprise a conductive material or an insulating material. The fibre may comprise a conductive material and the conductive material may be a conductive 2D material, optionally wherein the conductive material is a different 2D material to the 2D material of the first ink composition. The conductive material may be graphene, GO, rGO, a MXene (e.g. Ti₃C₂, Ti₂C, Mo₂C, NB₂C) or a metal (e.g. a metal nanowire, metallic flakes).

The fibre may comprise an insulating material and the insulating material may be a polymeric material or an insulating 2D material (e.g. h-BN, BiOCl).

The solvent may comprise an organic solvent. Suitable solvents for an ink composition described herein include an organic solvent, mixtures of organic solvents or mixtures of water and one or more organic solvent.

The process may further comprise repeating the steps of immersing the fibre in the first ink composition comprising and removing the fibre from the first ink composition and drying the fibre.

The process may further comprise:
immersing the fibre in a second ink composition comprising a 2D material that is different to the 2D material of the first ink composition and an organic solvent; and
removing the fibre from the second ink composition and drying the fibre; optionally wherein the process further comprises repeating the steps of immersing the fibre in the second ink composition comprising and removing the fibre from the second ink composition and drying the fibre.

Drying the fibre may further comprise heating the fibre coated with a 2D material, optionally heating to at least 100° C., at least 200° C., at least 300° C. or at least 400° C., optionally under an inert atmosphere (for example N₂).

Providing a fibre may comprise spinning or extruding a fibre precursor material.

The process may be carried out in a continuous manner.

The process may further comprise weaving a plurality of the fibres coated with a first 2D material into a textile.

Also provided herein is a fibre or a textile coated with a 2D material as prepared according to the process described herein.

Also provided herein is a coated fibre comprising:
a core fibre; and
a coating comprising a 2D material, provided directly on the surface of the core fibre;
wherein the coating coverage is, for example greater than about 60%.

The coating may consist essentially of the 2D materials.

The coating coverage may be greater than about 70%, greater than about 80%, greater than about 90%, or greater than about 95%. The coating coverage may be complete. The coating coverage may be about 100%.

The coated fibre may comprise a second coating, provided directly on the surface of the coating. For example, the coated fibre may comprise a first coating comprising (e.g. consisting essentially of) a first 2D material, provided directly on the surface of the core fibre, and a second coating comprising (e.g. consisting essentially of) a second 2D material, provided directly on the surface of the first coating. The first and second 2D material may be different.

The 2D materials may be graphene, hexagonal-boron nitride (h-BN), graphene oxide (GO), reduced graphene oxide (rGO), transition metal dichalcogenides (e.g. MoS₂, MoSe₂, MoTe₂, WSe₂, WS₂, InS₂, HfS₂), hafnium oxides, transition metal oxides, MXenes (e.g. Ti₃C₂, Ti₂C, Mo₂C, NB₂C) or BiOCl.

The core fibre may comprise a conductive material or an insulating material.

The core fibre may comprise a conductive material and the conductive material may be a conductive 2D material, optionally wherein the conductive material is a different 2D material to the 2D material of the first ink composition. The conductive material may be graphene, graphene oxide, reduced graphene oxide, a MXene (e.g. Ti₃C₂, Ti₂C, Mo₂C, NB₂C) or a metal (e.g. a metal nanowire, metallic flakes).

The fibre may comprise an insulating material and the insulating material may be a polymeric material or an insulating 2D material (e.g. h-BN, BiOCl).

Also described herein is the use of a fibre or textile coated with a 2D material as described herein for the use as an electronic component (e.g. but no limited to transistor, diode, Light emitting diode), optionally as a capacitor, resistor, inductor, or as a conductor or a sensor.

Also described herein is an electrical device comprising the fibre coated or textile coated with a 2D material described herein, optionally wherein the electrical device is an electronic component (e.g. but no limited to transistor, diode, Light emitting diode), optionally as a capacitor, resistor, inductor, or as a conductor or a sensor.

### SUMMARY OF FIGURES

FIG. 1 shows a vertical configuration photodiode. rGO fibre coated in MoS₂ and MXene.

FIG. 2 shows an example of a continuous, e.g. in-line spinning system. The fibres are spun out and coagulated, followed by coating bath with furnace to evaporate the solvent.

FIG. 3 shows a GO fibre coated in monolayer MoS₂.

FIG. 4 shows a vertical configuration of fibre capacitor (left) and fibre transistor (right).

FIG. 5 shows a wet spinning set up for fibre production. The set up was drawn in part (a) to show the method mechanism with a picture of the set up (b).

FIG. 6 shows (left) a multi-layer core-shell structure with a polymer core and a rGO-MXene/MoS₂/rGO-MXene layer and (right) a core-shell structure with a rGO core, an active layer of MoS₂ and an Ag coating.

FIG. 7 shows optical microscopy images of a) original rGO fibre, b) MoS₂ coated rGO fibre, c) the h-BN coated rGO fibre; d) an origin PLA fibre, and e) rGO coated PLA fibre.

FIG. 9 shows Raman spectra of fibres and their coatings. a) rGO fibre before (top) and after coating with h-BN (bottom). b) rGO fibre before (top) and after coating with MoS₂ (bottom). c) PLA fibre before (top) and after coating with rGO (bottom).

FIG. 9 shows output curves and a picture of the rGO/MoS₂ fibre photoconductors.

FIG. 10 shows A fibre-shaped capacitor and its capacitance measurement. a) structure of the fibre-shaped capacitor. b) optical microscopy image of the fibre-shaped capacitor. c) cyclic voltammetry measurements under different scan rate of the fibre-shaped capacitor. d) Electrochemical impedance spectroscopy of the fibre-shaped capacitor.

### DETAILED DESCRIPTION

Described herein is a process for preparing a fibre coated with a 2D material thin film. This process may be fully solution processable from start to finish, a low temperature synthesis and can be made into a continuous process. The fact that it is solution processable and continuous enable easy scale up to commercial-sized production. This makes the process highly attractive for wearable electronics, smart textiles and technical clothing in healthcare and wellbeing, military, aerospace and sportswear applications.

Accordingly, described herein is a process for preparing a fibre coated with a 2D material comprising:
providing a fibre;
immersing the fibre in a first ink composition comprising a 2D material and a solvent; and
removing the fibre from the first ink composition and drying the fibre to form a fibre coated with a 2D material.

The resulting product is a solution processable, flexible and conducting fibre that can detect light and generate electrical power based on two-dimensional materials, such as, but not limited to, rGO, h-BN and Few Layer MoS₂.

Both the fibre and any of the ink compositions described herein may comprise 2D materials. Either, both or all may, therefore, act as the source of the 2D material in the coated fibre. As would be appreciated, either the fibre or any one or more coating layers may comprise (e.g. consist essentially of) a 2D material, or a combination thereof (such as both/all).

The 2D materials are crystals consisting of single-layer atoms or few-layer atoms (for example, 2, 3 or 4 layers), in which the in-plane interatomic interactions are much stronger than those along the stacking direction. 2D materials may have one dimension (e.g. thickness) which is either as thick as one atom or as thick as the minimum number of atomic planes which compose its chemical structure. Substances with a thickness of a few nanometres or less in one dimension only may also be considered a 2D material.

Electrons in these 2D materials are free to move in the two-dimensional plane, but their restricted motion in the third direction is governed by quantum mechanics.

2D materials may have high aspect ratios (i.e. the size to thickness ratio), for example greater than about 2, greater than about 10, greater than about 100, greater than about 500, or greater than about 1000. Aspect ratio may be determined from the particle size (which can be calculated using for example laser diffraction) and the thickness (which can be determined from SEM). Aspect ratios of some exemplary 2D materials (for example, 2D materials that may be used in ink compositions as coatings) are set out in table 1 below.

TABLE 1
Aspect ratio of example 2D materials

| Material | Literature aspect ratio |
|---|---|
| Graphene Oxide | 5000-20000 |
| Reduced graphene oxide | 1000-13500 |
| Hexagonal boron nitride | 50-1500 |
| Ti₃C₂ | / |
| Ti₂C | / |
| MoS₂ | 2-100 |

The 2D material family has extended to more than one thousand members based on theoretical predictions. To date, tens of these materials have been synthesized experimentally. Generally, 2D materials can be categorized into four types (including graphene family, MXenes, transition metal chalcogenides, and 2D oxides) according to their components and atomic structures.

2D materials include boron nitride e.g. h-BN, GO, rGO, transition metal dichalcogenides (e.g. MoS₂, MoSe₂, MoTe₂, WSe₂, WS₂, InS₂, HfS₂), hafnium oxides, transition metal oxides, MXenes (e.g. Ti₃C₂, Ti₂C, Mo₂C, NB₂C) and BiOCl.

A fibre may comprise (e.g. consist essentially of) GO, rGO, or MXenes (e.g. Ti₃C₂, Ti₂C, Mo₂C, NB₂C), or a mixture thereof. Preferably a fibre may comprise (e.g. consist essentially of) GO, rGO, or MXenes (e.g. Ti₃C₂, Ti₂C, Mo₂C, NB₂C).

A 2D materials in ink compositions may include BN, e.g. h-BN, GO, rGO, transition metal dichalcogenides (e.g. MoS₂, MoSe₂, MoTe₂, WSe₂, WS₂, InS₂, HfS₂), hafnium oxides and MXenes (e.g. Ti₃C₂, Ti₂C, Mo₂C, NB₂C).

A 2D material may be a conductive material (a conductive 2D material). A conductive material, as described herein, is a material that is electrically conducting at room temperature (i.e. 25° C.). For example, a material that has an electrical conductivity of at least about 1 S m⁻¹ at 25° C., e.g. at least about 10 S m⁻¹ at 25° C.

Graphene is the most popular 2D material with a hexagonal structure of carbon atoms arranged in a honeycomb lattice. Owing to this structure, graphene shows near-ballistic transport and high mobility (u, up to 3×10 ⁶ cm ² V⁻¹ s⁻¹), biocompatibility, chemical stability. These properties enabled graphene and its derivatives to be applied as a possible alternative to traditional electrodes in many applications, including flexible electronics, biomedical systems and nanoelectronics. GO and reduced rGO are graphene sheets modified by chemical reactions introducing epoxy, hydroxyl, and carboxyl groups. Both GO and rGO shown highly tuneable electric and chemical properties and easy functionalisation.

MoS₂ is a transition metal dichalcogenide with the formula MoS₂ and its monolayer/few layers form is another 2D material that has gained interest in recent years. In the bulk phase, MoS₂ has an indirect bandgap of 1.29 eV and hence is not very useful for electronic and opto-electronic uses. However, monolayers MoS₂ which can be exfoliated from bulk MoS₂ results in a change from being an indirect bandgap semiconductor to a direct bandgap semiconductor with a bandgap of 1.89 eV. Coupled with its high absorption coefficient, highly flexibility and high mechanical strength, mono/few-layer MoS₂ becomes a suitable for a wide range of applications such as flexible electronics, photodetectors, sensors and solar cells.

A 2D material may be an electrically insulating material, for example, h-BN or BiOCl.

H-BN is another 2D material and consists of hexagonal rings in alternating B and N atoms linked by covalent bonds. Its chemical, electrical, mechanical, and thermal resistance make it a perfect encapsulating material or insulating layer in devices manufacturing. The insulating, chemical inert layer of h-BN can also limit the formation of dangling bonds which leads to charge traps. Together with its large band gap (5.5 eV) give a solution to gate leakage current in small size devices design.

The coating is formed from an insulating material (e.g. an insulating 2D material such as h-BN), the core fibre is preferably formed from a conductive material (e.g. a conductive 2D material or a metal) and/or additional coatings formed from conductive materials are incorporated into the fibre in order to provide the desired conductivity for the end coated fibre.

The process described herein provides for a coating of these 2D materials on a fibre. The process comprises immersing the fibre in an ink composition comprising a 2D material and then drying the fibre to form a coating.

An ink composition described herein comprises a suspension or dispersion of 2D material in a solvent, for example an organic solvent.

The 2D material may be present in an ink composition described herein at an amount of at least about 0.10 mg ml⁻¹, preferably at least about 0.15 mg ml⁻¹, preferably at least about 0.20 mg ml⁻¹, preferably at least about 0.25 mg ml⁻¹, preferably at least about 0.30 mg ml⁻¹, preferably at least about 0.35 mg ml⁻¹. The 2D material may be present in an ink composition at an amount of at most about 5 mg ml⁻¹, preferably at most about 4 mg ml⁻¹, preferably at most about 3 mg ml⁻¹, preferably at most about 2 mg ml⁻¹, preferably at most about 1 mg ml⁻¹, preferably at most about 0.50 mg ml⁻¹. The 2D material may be present in an ink composition at an amount of about 0.10 mg ml⁻¹ to about 5.00 mg ml⁻¹, preferably about 0.10 mg ml⁻¹ to about 2.50 mg ml-1, preferably about 0.10 mg ml⁻¹ to about 1.00 mg ml⁻¹.

The ink compositions described herein preferably comprise a solvent. Suitable solvents for an ink composition described herein include an organic solvent, mixtures of one organic solvents or mixtures of water and one or more organic solvent. As would be appreciated, volatile solvents are preferable. Suitable organic solvents include N-methylpyrrolidine, polyvinylpyrrolidine, dichlorobenzene (e.g. ortho-dichlorobenzene), organic alcohols (such as ethanol and propanol) and polysulfonic acid and combinations thereof. For example, the solvent may be a mixture of N-Methylpyrrolidone and dichlorobenzene (e.g. ortho-dichlorobenzene), a mixture of propanol and poly-vinylpyrrolidone, a mixture of ethanol and water, or a mixture of water and polysulphonic acid.

The ink compositions described herein may further comprise surfactants and stabilizers or a combination thereof. It would be appreciated that the surfactants and stabilizers are preferably those that would be removed during the drying and/or hearting (e.g. annealing) of the coating such that the dried coating is substantially free of these components, for example such that the electrochemical performance of the coating is not influenced.

Exemplary surfactants for use in the ink compositions described herein include carboxymethyl cellulose (CMC), sodium carboxymethyl cellulose, sodium deoxycholate (SDC), polyvinylpyrrolidone (PVP) and sodium cholate (SC) and combinations thereof. For example, ink compositions comprising a 2D material and a surfactant include those listed in Table 2 below.

TABLE 2
Possible surfactants in the ink

| Ink | Surfactant |
|---|---|
| h-BN | Carboxymethyl cellulose (CMC) |
| h-BN | Sodium carboxymethyl cellulose |
| h-BN | Sodium deoxycholate (SDC) |
| graphene | Sodium cholate (SC) |
| MoS₂ | Polyvinylpyrrolidone (PVP) |
| MoS₂ | Sodium deoxycholate (SDC) |

Submersion in a concentrated ink composition followed by slow evaporation until the fibres are dry, has shown great promise in achieving a uniform coating of 2D materials via a solution, low temperature process. The technology is suitable for fibre decoration for different kinds of coatings and fibres among various 2D materials. For example, through this dry coating process, materials like h-BN and graphene can be added on the surface of rGO or h-BN fibres to achieve functionalisation.

This process can be used to create advanced electronic fibres all-based on 2D material with a core-shell structure. The fibres are flexible and the different combination of 2D material coating can enable various tailored properties such as electrical conductivity, light-sensitivity, motion sensing, energy storage and generation, thermal conductivity, biosensing. The mechanical response of the fibres is suitable for weaving, knitting and standard textile integration processes.

The process of the present invention (which may be known as a dry coating process) enables the preparation of coated fibres having tailorable electronic properties, whilst maintain the underlying mechanical properties of the core fibre. The coating produced by said dry coating process of the present invention may have a high degree of morphological uniformity. The process of the present invention also allows for the production of very thin (e.g. a thin as about 4 nm) coating, or thicker depending on the desired properties.

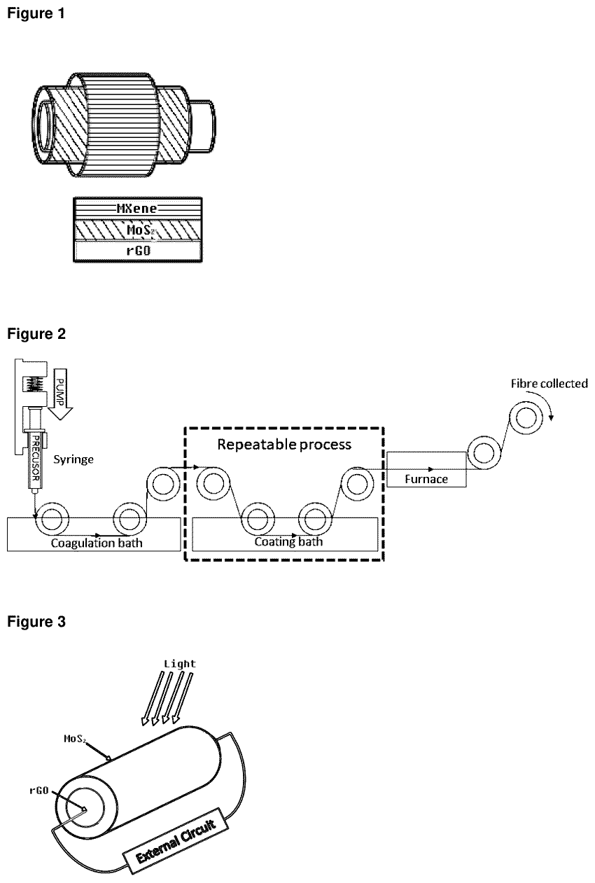

More advanced electronic devices can be created on a fibre, that can act as a photodiode or a solar cell. This idea involves putting an extra conducting coating on top of the semiconducting shell, as seen in FIG. 1. This multi-shell structure could be achieved using a conducting 2D material coating based on graphene or MXenes which can provide a transparent and conducting coating which collects the photo-generated charge carriers in the 2D semiconducting shell. Having the materials layered in this vertical multi-shell configuration would mean the device would operate as a Schottky photodiode rather than a photoconductor and hence would not require an external battery. When light is shone on this device, a photocurrent would be generated which would then be transported out of the device via the core rGO fibre. Not only could this type of fibre be used as a way of detecting light, but it could also be used as a solar cell to generate renewable energy for wearable systems.

Also provided herein, therefore, is a coated fibre comprising:
a core fibre; and
a coating comprising (e.g. consisting essentially of) a 2D material, provided directly on the surface of the core fibre;
wherein the coating coverage is greater than about 90%.

The coated fibre may comprise further coating layers. For example, the coated fibre may comprise a first coating comprising (e.g. consisting essentially of) a first 2D material, provided directly on the surface of the core fibre, and a second coating comprising (e.g. consisting essentially of) a second 2D material, provided directly on the surface of the first coating. The first and second 2D materials may be different 2D materials.

Characterization of the coating or coatings may be carried out by the chemical identification of the coating (Raman, EDX, XRD), changes on the fibre surface (observed from TEM, SEM, OMS images), and achievements or improvements on the coated fibre (e.g., increased strength, conductivity).

For example, the quality of coating can be examined by identifying the appearance of coating through Raman spectroscopy, and testing the functionalisation of the fibre (e.g., measurements on the photocurrent of MoS₂ coated rGO fibre, or insulation of h-BN coated rGO fibre).

Raman mapping spectroscopy may be used to calculate the statistical appearance of the coating material over the core fibre. Using the process of the invention, coating coverage percentages of greater than about 90% may be obtained, and as high as 99.3%. This corresponds to a very high coverage and a minimal frequency of holes.

The coating coverage may be complete. The coating coverage may be about 100%.

Raman spectroscopy may give unique resonant features which identify the presence of a specific material, even in small quantities. For example, it can identify the presence of a thin MoS₂ layer onto a graphene fibre, with a spatial resolution of 10 μm. This makes it a powerful tool to map the coverage of the coating by directly probing the presence of the 2D material desired. In addition, the unique Raman fingerprints for a specific material evolve with crystallinity, doping and defects, so they can be also used to identify the quality of the coating.

Raman spectra may be acquired on a Raman spectrometer at 532 nm with a 50× objective and an incident power of 0.16 mW. Using the mapping function, Raman spectra on the grid crossing points can be collected. Trough counting on the spectra with coating materials' Raman typical peaks the coating coverage of the fibre can be caluculated by Equation 1:

$$Coating Coverage = \frac{number of spectra with coating {materials}^{′} typical peak}{number of spectra taken in the Raman mapping} \times 100 \% \qquad Equation 1$$

There are some features also used to identify the coating, but as would be appreciated, this depends on the particular coating, such as observing the change on fibre surface (e.g., h-BN coating on rGO fibre shown colour change from black to white, rGO coating on PLA fibre makes fibre from transparent to black), or change on fibre dimeter (the thickness if h-BN dielectric layer in a fibre capacitor is possible to measure under optical microscopy).

To better define the coating through quantification, Raman mapping over the fibre may be used. Through identify the appearance of the coating chemicals over the fibre we can understand the degree of coverage on the fibre easily. This measurement is also convenient to repeat to provide statistically reliable results.

In addition, morphological parameters such as the thickness uniformity and the presence of holed and irregularities in the coating can be determined by a regular measurement of the difference between the thickness of the fibre before and after the dry coating step. This measurement can be repeated for multiple coating steps to extract the exact thickness of the overall coated shell.

Digital optical analysis can be used to optically identify the uniformity of the coverage of the coating by optical transmission or reflectance. This can be used to calculate the root mean square of the height of the coating. The height of coating may be considered the thickness of coating, which may be calculated based on the difference on fibre diameter before and after the coating process. The standard deviation may show the uniformity of the coating thickness. For example, for a coating comprising (e.g. consisting essentially of) h-BN on a fibre comprising (e.g. consisting essentially of) rGO may have an average thickness of about 11.55 μm with standard deviation of about 2.97 μm.

As would be appreciated, the thickness of the coating depends on the 2D material in the coating (given the atomic thickness of an individual flake varies from one material to another), however using the process of the present invention coatings as thin as about 4 nm and as thick as about 1 μm may be formed.

A correlation of the chemical mapping of the surface of the fibres together with information of the fibre thickness difference as a function of the different coating steps represents a suitable figure of merit for a quantitative definition of the coating.

As used herein, a “fibre” refers to a single fibre (filament). A plurality of fibres may together form a multifilament, yarn, tow, rod, panel, braid, ribbon, tape, woven or non-woven fabric, ply, mat, roving, or mixture thereof, and the like. A tow comprises a bundle of untwisted filaments. A yarn comprises a bundle of twisted filaments. Tapes or ribbons may comprise woven fibres or non-woven flattened tows. Primary fibre materials may be assembled into fabric or sheet-like structures, woven fabrics and non-woven mats. The present invention may have the benefit of being able to provide a coated single fibre.

A fibre may have curved cross-section. For example, a fibre may comprise a semi-circular cross section portion. A fibre may have an oval or circular cross section. A fibre may be cylindrical.

A skilled person would appreciate that any fibre materials may serve as the substrate in the process described herein. A fibre may comprise (preferably, consist essentially of) a conductive material or an insulating material.

The fibre may comprise a conductive material. Preferably, the fibre consists essentially of said conductive material. A conductive material may be a 2D material, for example a different 2D material to the 2D material of the ink compositions. For example, the fibre may be formed from (i.e. comprise, e.g. consist essentially of) graphene oxide, reduced graphene oxide or MXenes (e.g. Ti₃C₂, Ti₂C, Mo₂C, NB₂C). Alternatively, the fibre may be a metal nano-wire.

The fibre may comprise an insulating material. Preferably, the fibre consists essentially of said insulating material. An insulating material may be a polymeric material. A polymeric material may be, for example, a polymer or a polymer composite. Examples of suitable polymeric materials include but are not limited to polyesters, polylactic acids, polyamides, polyacrylates, polyacrylamides.

The fibres described herein may be formed from any suitable spinning or extrusion method known to one of skill in the art, including wet-spinning, electro-spinning, microfluidic spinning, thermal extrusion. For example, 2D material fibres may be formed from wet-spinning. Polymeric fibres may be formed from thermal extrusion, electro-spinning or microfluidic spinning. Metal fibres may be formed by melt-spinning.

The present invention as described herein is a solution processable, flexible and conducting fibre that can detect light and generate electrical power based on 2D materials, such as, but not limited to, rGO, h-BN and few layer MoS₂.

For example, GO can be continuously wet spun into long fibres which can be reduced to rGO fibres. These fibres are highly conducting, flexible and strong. Other conducting 2D materials such as MXene (e.g. Ti₃C₂) can be wet spun into highly conducting fibres. MoS₂ is a photoactive material. It can be in bulk form or in a few layer/monolayer form, similar to graphite vs graphene. Monolayer or few-layer Transition Metal Dichalcogenides, TMD (such as MoS₂, MoSe₂, MoTe₂) flakes are of particular interest in optoelectronics. On its own MoS₂ is not very responsive to light. However, when a junction is formed with rGO, the electrical response to light (in the form of photo-generated current efficiency or photo-generated energy) is significantly increased. For example MoS₂/rGO photodetector technology in planar form (on flat substrates) has been previously reported, showing high photocurrent efficiencies for this technology.

The process described herein may be carried out in a continuous manner. For example, by coating of a continuously spun or extruded fibre. Two or more coatings may be applied by sequentially repeating the coating process, in a continuous manner. See, for example, FIG. 2.

The process described herein may be used to develop optoelectronic devices based on fibre structures that can detect light. The same technology can be used to produce solar energy from fibre-based devices. For example, a core/multi-shell fibre device composed of conducting 2D material composite (e.g. rGO flakes) core fibre, coated in a semiconducting 2D material thin film (e.g. MoS₂, see FIG. 3) may be used as a photoconductor, meaning that an external applied voltage is required to see a response to light. When light is shone on the fibre, the conductivity of the MoS₂ layer changes and a change in the current travelling through the fibre should be observed.

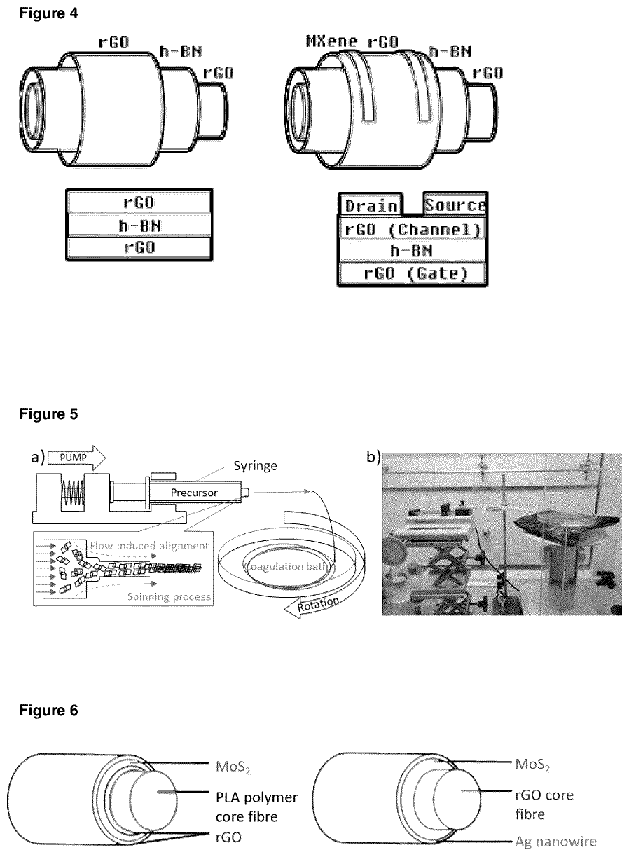

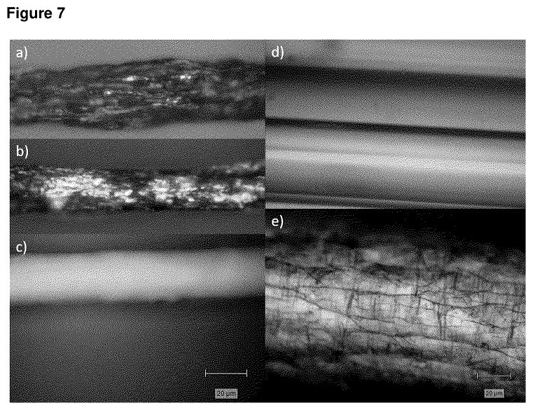

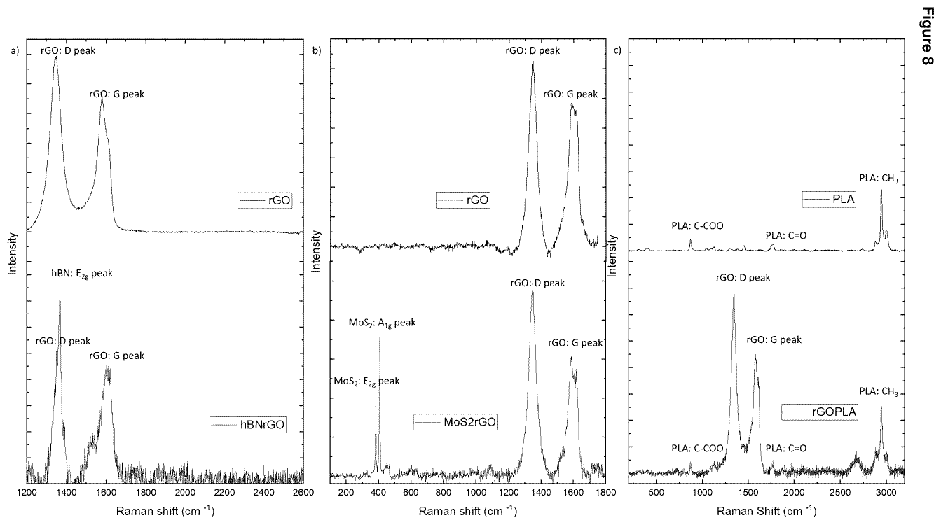

The process described herein could also be used to develop other fibre-based devices for e-textile applications. A fibre-based capacitor can be built in a similar core-shell structure as shown in FIG. 4. rGO electrode made through reduced wet spun GO fibre provides a strong, high conductive and flexible basement for the further coated h-BN insulate layer and the rGO conductive layer, constitutes a knittable fibre capacitor. Further decorations on this composition will bring us various flexible devices. Through building high conductive electrodes (for example: MXene electrodes) on the outer conductive layer, this device could work as a transistor which can respond to the change on electronic field.

This fibre processing method shown potential to benefit various regions. The continuously wet spun long h-BN fibres were used to characterise the thermal conductivity of the material.

The fibre technology described herein has several advantages over and above existing non fibrous photodetectors. The fibres are highly flexible, able to detect light from 360° and are able to be woven into textiles to make integrated smart fabrics and wearable devices. Furthermore, the solar cell fibre proposal promises even more advantage as it would enable entirely self-powered, renewable smart fabrics.

This technology has the potential to solve several problems in the wearable technology market. Not only could this technology enable fully wearable photodetectors, but the solar cell fibres could enable self-powered, fully wearable electronic systems that use renewable energy from the sun, and wearable biosensors. Some of the problems/applications this fibre could solve include, but are not limited to:
Healthcare—the fibres could be used in smart textiles that help monitoring of certain body functions and of the environment and point of care diagnosis.
Deep sea exploration and work in low light areas such as in mines: These fibres are light, flexible and strong so could easily be integrated into the suits of people working in low light environments to provide real time data on the surroundings of the user.
Technical heavy-duty suites for monitoring of body parameters during labour in extreme working environments.
Military: Similarly, the fibres can be easily incorporated into tactical suits for the military and even for space exploration.
Displays and Interfaces: These fibres could be incorporated into devices and displays to increase flexibility.

The process described herein used to make these fibres may be carried out entirely solution based, enabling a continuous and scalable manufacturing process, compatible with processes already used by the textiles industry.

Throughout the description and claims of this specification, the words “comprise” and “contain” and variations of the words, for example “comprising” and “comprises”, mean “including but not limited to”, and are not intended to (and do not) exclude other components. In any of the embodiment described herein, reference to “comprising” also encompasses “consisting essentially of”.

Features described above in relation to each aspect of the present invention also represent features of each other aspect of the present invention subject to a technical incompatibility that would prevent such a combination of preferred features. Furthermore, it will be evident to the skilled person that advantages set out above in respect of each aspect of the present invention are also offered by each other aspect of the present invention.

### Examples

The following examples are merely illustrative examples of the invention described herein and are not intended to be limiting upon the scope of the invention.

### Graphene Oxide Synthesis and Fibre Spinning

### Graphene Oxide Synthesis

Graphite (0.5 g) and sulfuric acid (100 mL) were mixed and stirred in a flask for 24 h. Then, KMnO₄ (5 g) was added to the mixture dropwise and stirred for another 24 h. The mixture was transferred into an ice bath, and deionised water (100 mL) was poured dropwise into the mixture. During the drop process, the temperature should be controlled under 25° C. and the whole time is about 1 hour. After waiting for 30 minutes, add H₂O₂ (25 mL) to the mixture dropwise. The colour of the GO solution changed from atrovirens to dark brown. The solution was then washed by centrifugation with HCl and deionised water to remove the impurity until pH was close to 7.

### Reduced Graphene Oxide Fibre Spinning

GO precursor was transferred into a syringe and injected out into a rotated glacial acid coagulation bath. This wet spinning set-up was shown in FIG. 5. The precursor was squeezed at a rate of 10 mg h⁻¹. The Fibre was then collected from the coagulation bath and dried, further reduced to rGO fibre by hydrogen iodide.

### Fibre-Shaped Photodetector

### Electrochemical Exfoliation of MoS₂

High purity MoS₂ crystal was connected to a Potentiostat via a steel alligator clip electrode. A graphite rod counter-electrode was used. The electrode and crystal were submerged in an electrolyte of 5 mg mL⁻¹ tetra-ammoniumbromide in acetonitrile. The crystal was exfoliated at 8V for 1 hour. The electrolyte was then replaced with fresh electrolyte and the process was repeated 2 more times. The expanded crystal was removed from the electrolyte solution, washed with ethanol and then was sonicated in 10 mL N-methylpyrrolidone (NMP) for 1 hour and then centrifuged at 20,000 rpm for 30 minutes. The supernatant was removed to give a pale brown/yellow clear ink. A solvent exchange was carried out into to transfer the ink into IPA via vacuum distillation. The NMP ink was reduced to a volume of less than 1 mL by heating the ink under vacuum in a water bath at 80° C. After cooling, 2.5 mL of IPA was added to the reduced dispersion and then sonicated for 1 hour to give 3 mL of dark brown liquid as the final product.

### Polylactic Acid (PLA) Fibre Spinning

Ingeo 4043D PLA polymer pellets were extruded by a Filament Extruder under 150° C. Fibre was stretching by a motor rotated in 6 rpm.

### Photodetector Synthesis Through Evaporation Deposition Process

Two structures of photodetectors were designed as shown in FIG. 4.

PLA fibre was placed in small petri dishes and submerged in approximately 0.1 mL rGO inks on a hot plate and heated gently till all solvent removed. The coated fibres were chemical reduced through hydrogen iodide wiping. Then, this rGO-PLA fibre was placed in small petri dishes and submerged in approximately 0.1 mL MoS₂ inks on a hot plate and heated gently till all solvent removed. The coated fibres were annealed in a nitrogen glove box at 400° C. for 30 minutes to remove the NMP and PVP in the ink, subsequently moved to dip and dried again using the GO water suspension and reduced by hydrogen iodide to form the core-shell structured fibre photodetector.

rGO fibre was placed in small petri dishes and submerged in approximately 0.1 mL MoS₂ inks on a hot plate and heated gently until all solvent removed. The coated fibres were annealed in a nitrogen glove box at 400° C. for 30 minutes to remove the NMP and PVP in the ink. Ag electrodes were drawn on the MoS₂ surface to form the core-shell structured fibre photodetector.

### Fibre-Shaped Capacitor

h-BN Exfoliation

10 mg mL⁻¹ h-BN powder was mixed with 55% v Ethanol H₂O solvent. The dispersion system was then moved to tip sonication to be exfoliated for 9 hours in an ice bath. The result was purified through 20 minutes 3,000 rpm centrifugation.

### Capacitor Synthesis Through Evaporation Deposition Process

rGO fibres were placed in small petri dishes and submerged in approximately 0.1 mL h-BN ink on a hot plate and heated gently till all solvent removed. This process is repeated until enough material appear on the fibre as characterised by Raman spectroscopy and optical microscopy. Another GO layer was dip coated on the dried rGO/h-BN fibre and thermal reduced under 300° C. for 30 min.

### Characterization

An Optical Microscope was used to capture images of the fibres. Magnifications of 2.5× and 10× were used to image the surface of the fibres. All UV/Vis absorbance spectrum were collected using a spectrometer. Raman spectra were acquired on a Raman spectrometer at 532 nm with a 50× objective and an incident power of 0.16 mW. A parameter analyser with a 100 mW cm² white light source and needle probes were used to accurately collect current vs voltage curves under light and dark conditions.

### Evaporation Deposition Process

Current fibre coating technical heavily relay on the fibre spinning set up. The majority method used to avoid this limitation is CVD or PVD, which is an expensive and toxic-agents involved process. These functionalization methodologies are not matching with the requirements on mass production of electronic fibres. In the evaporation deposition process we used in this work, coating materials were distributed in volatile solvents, coated around the fibre during the evaporation process under low-temperature. This method avoids the use of toxic agents, meets the requirements of wearable devices fabrication. It's also cheap and convenient, pave the way of mass production and in-line production of electronic fibres.

To figure out the universality of this evaporation deposition process among various 2D materials over different wired-shaped substrates, two commonly used core fibre materials, conductive material rGO from the wet-spinning process and insulate polymer PLA from a thermal extruder, were used as fibre substrate. rGO, MoS₂, h-BN were chosen as functionalisation materials, which can form devices components covered various electric elements: conductors (rGO), semiconductors (MoS₂), insulators (h-BN) and functional materials (optoelectrical active MoS₂). Through assembling of these electronic elements, two kinds of fibre-shaped photodetectors and one fibre-shaped capacitor were designed fabricated using the evaporation deposition process.

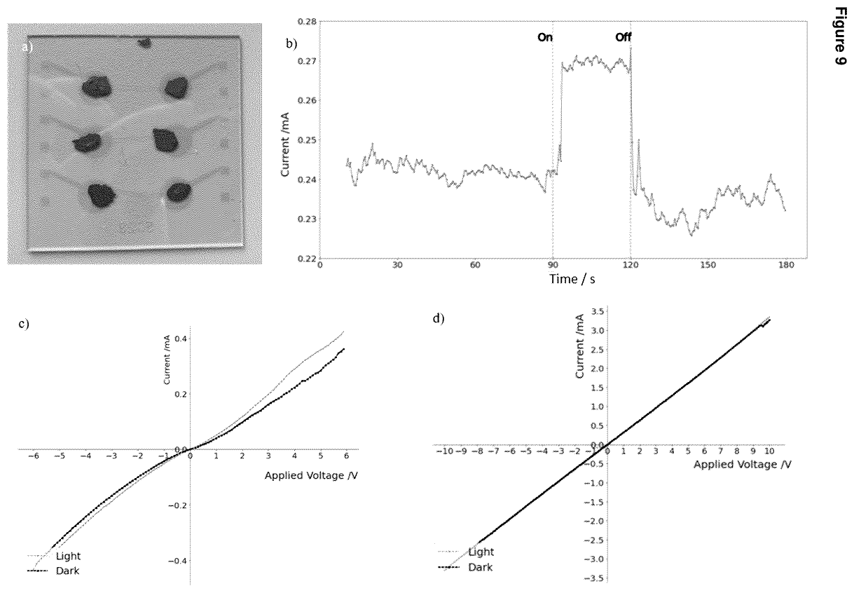

In this study, MoS₂ and h-BN coating on rGO fibre, and GO coating on PLA fibre were examined during the device fabrication (FIG. 7). Compared with the original rGO fibre (FIG. 7a), obvious coatings can be seen on the fibre surface like the reflective MoS₂ (FIG. 7b) and white covering from h-BN (FIG. 7c). The rGO coating on PLA fibre (FIG. 7e) is also clear to be observed from the optical microscopy images. The coatings are able to completely cover the core fibre to form a nice core-shell structure with a good uniformity tell from a relatively stable diameter difference before and after the evaporation deposition process.

Coating is also identified through Raman spectroscopy (FIG. 8). In the rGO Raman spectrum, there are typical peaks D peak around 1350 cm⁻¹ (responding to disorder due to sp³ carbon bonds) and G peak at 1580 cm⁻¹ (responding to carbon-carbon bonds) give an intensity ratio ID/IG of 1.31, indicated the oxidizing degree of rGO. The h-BN Raman spectrum gives a peak at 1365 cm⁻¹ attributes to the E_{2g} vibration, and the MoS₂ Raman spectrum shows peaks at 383 cm⁻¹ (E_{2g}) and 407 cm⁻¹ (A_{1g}). On the evaporation deposition coated rGO fibres, the peaks of h-BN and rGO, and the peaks of MoS₂ and rGO can both be observed on the spectra. The rGO coated PLA fibre can be characterised in the same way. Besides of the PLA typical peaks at 873 cm⁻¹, 1770 cm⁻¹, and 2944 cm⁻¹, rGO peaks can also be observed on the spectrum. The functionalisation can be further assessed from the performance of the devices.

### Fibre-Based Photodetector

The photodetectors work based on the modification by MoS₂ of current in GO coating. Graphene has a zero-band gap and hence its absorption coefficient is very low meaning graphene only absorbs around 2.3% of incident light. Its high carrier mobility combined with its poor absorption make it poor as a current generator, but excellent as a current carrier. Therefore, a photoactive material MoS₂ is used to enhance the photodetector.

To successfully fabricate a photodetector using rGO and MoS₂, a MoS₂ coating over rGO fibre surface or rGO coating.

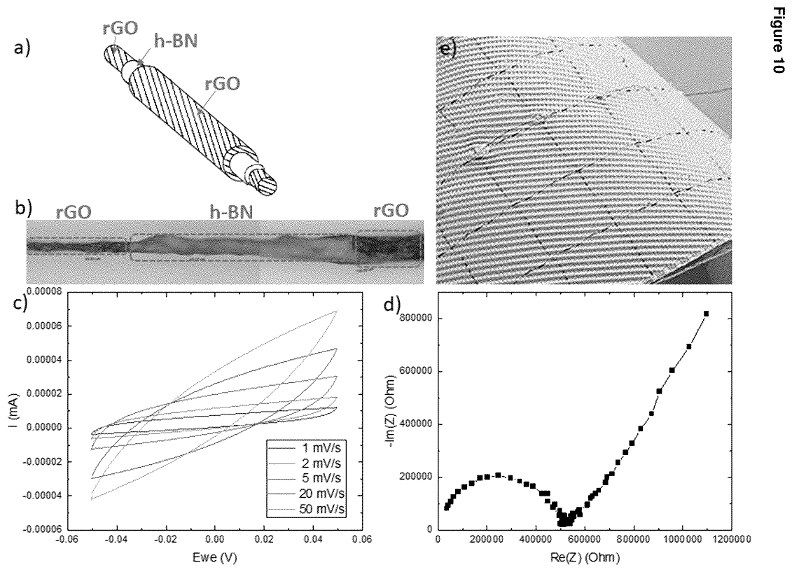

Current between the silver electrodes on the rGO fibre was measured as a function of time at a constant voltage and this fibre even showed photoresponse (FIG. 9b). Vertical lines were used to indicate the time when light is turn on or off. Clear changes between the lines on the current can be observed after the light been turned on and turned off, prove the MoS₂ coated rGO fibre is photoactive. Under 4 V voltage, this fibre shaped photodetector shown a responsivity at 5.58 AW⁻¹ and a detectivity of 1.19×10⁹ Jones.

The photo responding of the device was also measured by the current in rGO fibre between −5 V to 5 V voltage. A difference on this current can be measured with and without light (FIG. 9c). Compared with the responding from rGO fibre without MoS₂ coating (FIG. 9d), which is not photoactive, the successful functionalisation can be clear identified.

### Fibre-Based Capacitor

As a 2D material, layered structured h-BN is chemically inert and electrically inert, limited the formation of dangling bonds and further charge traps. These properties made it a good insulator in electronic devices. Using h-BN as an insulator to separate two conductive electrodes could build a capacitor, which can be transferred to a fibre shaped capacitor in a core-shell structure (FIG. 10a).

Through the evaporation deposition, a h-BN coating completely covered the rGO fibre, followed by another layer of rGO. This structure can be observed under microscopy image (FIG. 10b).

The coated fibre showed a Young's modulus of 17212.8 MPa with tensile strength around 164.6 MPa, confirming the fibre still is mechanically strong and flexible among rGO fibres.

The functionalisation was assessed through the capacitance measurement on this fibre shaped capacitor. The cyclic voltammetry (CV) measurements (FIG. 10c) and Electrochemical impedance spectroscopy (FIG. 10d) are commonly used measurement on capacitors. The quasi-rectangular shape CV curve under different scan rate state the electrochemical performance and reversibility on this fibre shaped capacitor, identify the successful working of the fibre shaped capacitor.

In the Electrochemical impedance spectroscopy, the semicircle obtained in the high frequency region corresponds to the charge-transfer process, and the straight line in high angle in the low frequency region shown the diffusion of ions between electrolyte and electrode. This spectrum confirms the capacitor's performance again, and also supports the calculation on specific capacitance which modified by length of 1.8 nF cm⁻¹ and an efficiency of 81%. We also tried to figure out the stability of the fibre capacitor, by repeat running the charge and discharge process. Under different scan rate, the specific capacitance tends to be relatively stable at a high scan rate. After 400 cycles, the Q charge of the capacitor is still relatively stable.

The stable running of the capacitor states the successful functionalisation of the rGO fibre using h-BN and rGO. This fibre shaped capacitor was woven on textile (FIG. 10e), pave the way to its further application on wearable devices.

This study demonstrates an evaporation deposition process that functionalised electronic fibres in a cheap, convenient and biocompatible method. The method is designed to be appliable over various 2D materials, including h-BN, MoS₂, and rGO over different fibre surface. This method can be used to functionalise the fibre for flexible applications, for flexible optoelectronics and electronic textiles. In particular, fibre shaped photodetector and fibre shaped capacitor were built to examine the functionalisation quality. Both devices work smoothly in a flexible shape, ensure this evaporation deposition process is a suitable functionalization method for wearable devices fabrication.

While preferred embodiments of the present invention have been shown and described herein, it will be apparent to those skilled in the art that such embodiments are provided by way of example only. It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

1. A process for preparing a fibre coated with a 2D material comprising:
providing a fibre;
immersing the fibre in a first ink composition comprising a 2D material and a solvent; and
removing the fibre from the first ink composition and drying the fibre to form a fibre coated with a 2D material.

2. The process of claim 1, wherein the 2D material is graphene, hexagonal-boron nitride (h-BN), transition metal dichalcogenides (e.g. MoS₂, MoSe₂, MoTe₂, WSe₂, WS₂, InS₂, HfS₂), graphene oxide (GO), reduced graphene oxide (rGO), hafnium oxides, a transition metal oxide, MXene (e.g. Ti₃C₂, Ti₂C, Mo₂C, NB₂C) or BiOCl.

3. The process of claim 1, wherein the fibre comprises a conductive material or an insulating material.

4. The process of claim 3, wherein the fibre comprises a conductive material and the conductive material is a conductive 2D material, optionally wherein the conductive material is a different 2D material to the 2D material of the first ink composition.

5. The process of claim 3, wherein the conductive material is graphene, graphene oxide, reduced graphene oxide, a MXene (e.g. Ti₃C₂, Ti₂C, Mo₂C, NB₂C) or a metal (e.g. a metal nanowire, metallic flakes).

6. The process of claim 3, wherein the fibre comprises an insulating material and the insulating material is a polymeric material or an insulating 2D material (e.g. h-BN, BiOCl).

7. The process of claim 1, wherein the process further comprises repeating the steps of immersing the fibre in the first ink composition and drying the solvent; or removing the fibre from the first ink composition and drying the fibre.

8. The process of claim 1, wherein the process further comprises:
immersing the fibre in a second ink composition comprising a 2D material that is different to the 2D material of the first ink composition and an organic solvent; and
removing the fibre from the second ink composition and drying the fibre; optionally wherein the process further comprises repeating the steps of immersing the fibre in the second ink composition comprising and removing the fibre from the second ink composition and drying the fibre.

9. The process of claim 1, wherein drying the fibre further comprises heating the fibre coated with a 2D material, optionally heating to at least 100° C., at least 200° C., at least 300° C. or at least 400° C., optionally under an inert atmosphere (for example N₂).

10. The process of claim 1, wherein providing a fibre comprises spinning or extruding a fibre precursor material.

11. The process of claim 1, wherein the process is carried out in a continuous manner.

12. The process of claim 1, wherein the process further comprising weaving a plurality of the fibres coated with a first 2D material into a textile.

13. A fibre coated with a 2D material or a textile as prepared according to the process of claim 1.

14. A coated fibre comprising:
a core fibre; and
a coating comprising a 2D material, provided directly on the surface of the core fibre;
wherein the coating coverage is greater than about 60%.

15. The coated fibre of claim 14, wherein:
a) the coating consists essentially of the 2D material; and/or
b) the coating coverage is greater than about 70%, greater than about 80%, greater than about 90%, greater than about 95%.

16. The coated fibre of claim 14, wherein the coated fibre comprises a second coating, provided directly on the surface of the coating.

17. The coated fibre of claim 14, wherein the 2D material is graphene, hexagonal-boron nitride (h-BN), transition metal dichalcogenides (e.g. MoS₂, MoSe₂, MoTe₂, WSe₂, WS₂, InS₂, HfS₂), graphene oxide (GO), reduced graphene oxide (rGO), hafnium oxides, transition metal oxides or MXene (e.g. Ti₃C₂, Ti₂C, Mo₂C, NB₂C).

18. The coated fibre of claim 14, wherein the core fibre comprises a conductive material or an insulating material.

19. The coated fibre of claim 14, wherein the fibre comprises a conductive material and the conductive material is a conductive 2D material, optionally wherein the conductive material is a different 2D material to the 2D material of the first ink composition.

20. The coated fibre of claim 14, wherein the conductive material is graphene, graphene oxide, reduced graphene oxide, a MXene (e.g. Ti₃C₂, Ti₂C, Mo₂C, NB₂C) or a metal (e.g. a metal nanowire, metallic flakes).

21. The coated fibre of claim 14, wherein the fibre comprises an insulating material and the insulating material is a polymeric material or an insulating 2D material (e.g. h-BN, BiOCl).

22. Use of the fibre coated with a 2D material or textile of claim 13 or 14 as an electronic component, optionally as a transistor, diode (e.g. a light emitting diode), capacitor, resistor, inductor, or as a conductor or a sensor.

23. An electrical device comprising the fibre or textile coated with a 2D material or few-layer material of claim 13 or 14, optionally wherein the electrical device is an electronic component, optionally a transistor, diode (e.g. a light emitting diode), capacitor, resistor, inductor, a conductor or a sensor.
